(19) United States
(12) Patent Application Publication
(10) Pub. No.: US 2022/0335368 A1
(43) Pub. Date: Oct. 20, 2022

(54) Method for Evaluating a Freight Order by Means of a Freight Order Evaluation System, and Freight Order Evaluation System

(71) Applicant: Daimler AG, Stuttgart (DE)

(72) Inventors: Juergen DIETRICH, Renningen (DE); Cagla Ege MEHLBEER, Esslingen am Neckar (DE); Frank ZIMMERMANN, Donzdorf (DE)

(21) Appl. No.: 17/609,208

(22) PCT Filed: Apr. 15, 2020
(86) PCT No.: PCT/EP2020/060515

§ 371 Date: Nov. 5, 2021

(30) Foreign Application Priority Data
May 8, 2019 (DE) 10 2019 003 233.0

(51) Int. Cl. G06Q 10/08; G01C 21/34

(52) U.S. Cl. CPC G06Q 10/087; G01C 21/343

(57) ABSTRACT

A method for evaluating a freight order for a lorry by a freight order evaluation system includes detecting a waiting time of the lorry, determining a route of the lorry depending on the waiting time, detecting a loading state of the lorry during the route, and evaluating the freight order depending on the waiting time and the loading state by an electronic computing device of the freight order evaluation system.

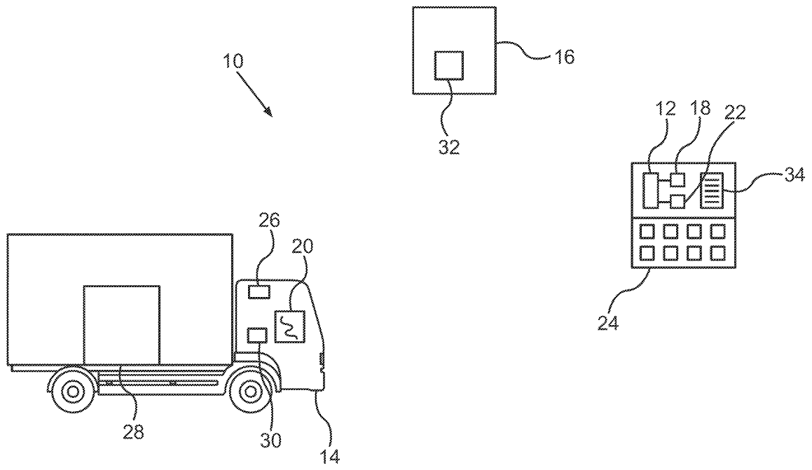

### BACKGROUND AND SUMMARY OF THE INVENTION

The invention relates to a method for evaluating a freight order for a lorry by means of a freight order evaluation system, in which a waiting time of the lorry is detected and a route of the lorry is determined in dependence on the detected waiting time and the freight order is evaluated in dependence thereon by means of an electronic computing device of the freight order evaluation system. Furthermore, the invention relates to a freight order evaluation system.

Various possibilities are known from the prior art for determining an optimal route for transporting a freight order or an optimal route for processing a large number of freight orders.

For example, US 2014/0324633 A1 discloses a computer system and associated method for implementing an online freight service marketplace. Freight service offers posted by carriers on the marketplace are matched to shipper requests. Compound service offers are formed from freight service offers that have service parameters that take into account load parameters of the freight service request. Compound service offers selected by the shipper are provisioned and reserved for subsequent dispatch. Role-based access controls within the marketplace restrict the visibility of sensitive information, such as carrier pricing and shipper identity. Automated freight facilitation includes shipper payment processing and shipping document creation. Status tracking functionality may be augmented with in-transit alerts and/or rescheduling to minimise the impact of common problems that threaten to defeat a shipment in progress.

Further, US 2011/0119200A1 discloses a method for determining a freight rate and fees and system therefor that can determine additional fees for additional distances, detention times, and distances of overtime transportation, other than the time and distance for a single service of consignment transportation. According to the method, after receiving waiting, loading, completion, rest, unloading, addition and additional loading instructions, a vehicle-mounted device receives position information of a transportation vehicle from a GPS satellite and associated information corresponding to the received instructions with the position information and a time when the instructions were received, for storage as service data. The server determines a reference freight rate based on designated loading and unloading points. Using information associated with the additional and extra unloading instructions, found from the service data, the server determines an extra driving distance to determine an extra distance fee therefor. The server determines a period of time during which the time required at each of the loading and unloading points exceeds a prescribed reference time to be a detention time, to determine a detention fee therefor. The server shall determine a distance travelled during the late night and early morning hours and a distance travelled on regular and public holidays to be an overtime transportation fee therefor.

The object of the present invention is to provide a method for evaluating a freight order and a freight order evaluation system by means of which a freight order can be evaluated in an improved manner.

One aspect of the invention relates to a method for evaluating a freight order for a lorry by means of a freight order evaluation system, in which a waiting time of the lorry is detected and, depending on the detected waiting time, a route of the lorry is determined and the freight order is evaluated depending thereon by means of an electronic computing device of the freight order evaluation system.

It is provided that a loading state of the lorry is detected during the route and, in addition, depending on the detected loading state, the freight order is evaluated by means of the electronic computing device.

This makes it possible for the freight order to be not only evaluated on the basis of the waiting times, but also on the basis of the loading state. In particular, this makes it possible for the freight order to be also evaluated in monetary terms, for example. Thus, a dispatcher can decide whether the freight order is accepted or not. Thus, an evaluation takes place with regard to the waiting times and the loading state.

A loading state can be considered to be, in particular, a full load, a partial load or an empty run.

In particular, variable costs and fixed costs, for example, can also be input into the freight order evaluation system by the dispatcher using an input device. In particular, by using the waiting times and by using the loading state, costs can be determined for the evaluation of the freight order.

Preferably, a number of freight orders can be processed during a route. In other words, several freight orders can be carried out with one route. For this purpose, the lorry can drive from a first destination, where for example a first freight order is accepted, to a second destination, where for example a second freight order is accepted. At a third location, for example, both freight orders can then be completed. In particular, empty runs can be recorded as a loading state or only a partial loading state. Thus, loading and unloading times can be taken into account in the evaluation of the freight order.

By means of the freight order evaluation system, corresponding times and costs that arise on specific routes can thus be taken into account, so that an estimate of the profitability for the future route can be carried out by means of the freight order evaluation system.

Furthermore, the freight order evaluation system makes it possible for the freight orders to be evaluated accordingly by a transport provider and stored, for example, in the electronic computing device of the freight order evaluation system. These can then be listed, with a particularly positively rated freight order being rated higher than a negative freight order. Thus, for example, an output regarding the rating of the ordering party can also take place. In particular, this makes it possible for a user of the freight order evaluation system to evaluate the customer accordingly, so that in particular corresponding order conditions can be negotiated in an improved manner.

According to an advantageous embodiment, depending on the evaluation of the freight order, the freight order is automatically accepted by means of the electronic computing device. In other words, the freight order can be received by means of the freight order evaluation system, then the freight order is evaluated and can then be automatically accepted by means of the electronic computing device. In particular, it can be provided, for example, that if the freight order has been evaluated monetarily, a monetary threshold value is used to decide whether the freight order is accepted automatically or not. This enables the freight order to be accepted automatically by means of the freight order evaluation system.

Furthermore, it has been found to be advantageous if the freight order evaluation system comprises an input device, and the waiting time and/or the loading state are detected by input from a user of the freight order evaluation system. In other words, it may be provided, for example, that the waiting times and/or the load status are input manually by the user. In particular, this is historical data relating to the waiting time and/or the load status. In particular, this makes it possible to reliably evaluate this freight order or a similar freight order in the future. This makes it possible to provide an improved freight order evaluation system.

In a further advantageous embodiment, position information of the navigation device of the lorry is used to determine the waiting time and/or load status information is used to determine the load status. In particular, a GPS position, for example, can be determined by means of the navigation device. This makes it possible to reliably determine the current position of the lorry. In particular, waiting times at a country border, loading and unloading times as well as rest times can be reliably determined. These can then be taken into account when evaluating the freight order. Furthermore, it is possible that loading state information, in particular regarding a weight, a volume, a date of delivery, a loading counter and/or a loading date are indicated. This data can be used, for example, by a transport management system (TMS). This allows information regarding the freight and start and delivery times, as well as the position thereto, to be assessed by means of the freight order assessment system.

Furthermore, it has proven to be advantageous if the freight order is additionally evaluated depending on a driver occupational state of a driver of the lorry during the route. In particular, the driving of the lorry, a break of the driver or the loading and unloading as well as further waiting times can be regarded as the driver occupation state. This makes it possible for these parameters to also be taken into account in the evaluation of the freight order. This thus improves the evaluation of the freight order.

Furthermore, it has proven to be advantageous if the driver occupation state is determined by means of an application of a mobile terminal of the driver. In particular, this can provide detailed information regarding the current driver occupation state. In particular, this can be used for waiting times of the driver, for example, in front of a loading ramp, at a border or at further checkpoints. The mobile terminal can, for example, be designed as an intelligent telephone, a so-called smartphone. In this way, the driving task can be evaluated reliably and with reduced effort.

It is also advantageous if the freight order is additionally evaluated during the route depending on the freight type of the freight order. For the freight type, fixed costs and variable costs as well as the profit on the freight can be taken into account. Furthermore, customs regulations and waiting times at loading ramps can be used on the basis of the freight. If, for example, a profitable freight is loaded, larger empty runs or partially empty runs may still be profitable. In particular, it is envisaged that the data relating to the freight is encrypted. This allows for an improved evaluation of the freight order.

According to a further advantageous embodiment, at least the waiting time and/or the loading state is stored in a memory device of the freight order evaluation system, and the freight order is evaluated depending on the stored waiting time and/or the stored loading state. The storage device can be provided internally in the lorry or, alternatively, the storage device can be provided as a storage device external to the lorry. For example, the storage device may be provided in the form of a back-end server or in the form of a cloud server. This enables the information relating to the waiting time and the loading state to be transmitted to the back-end server, for example by means of a transmission device of the lorry, whereby a user of the freight order evaluation system can access this information directly and can evaluate the freight order at an early stage. In particular, the particular freight order can be reliably evaluated on the basis of the historical information, i.e., the stored waiting time and/or the stored loading state. In particular, this allows a listing of the various freight orders with regard to their profitability to be carried out. In this way, a reliable evaluation of the freight order can be carried out.

In a further advantageous embodiment, the route is determined by means of the freight order evaluation system depending on at least two evaluated freight orders, in particular depending on a plurality of evaluated freight orders. The term “a plurality” means in particular more than two freight orders. In particular, the freight order evaluation system is then used to determine an optimal route depending on the plurality of freight orders. In particular, the corresponding waiting time and the corresponding loading state can then be taken into account when determining the route, whereby the route can be determined in an improved manner. In particular, the profitability of the route can be determined in an improved manner.

It has further proven to be advantageous if at least the waiting time and/or the loading state are weighted depending on a decision criterion, and the freight order is evaluated depending on the weighted waiting time and the weighted loading state. In other words, the waiting time and the loading state can be weighted differently. For example, a monetary value can be assigned to both the waiting times and the loading states for this purpose. These values may be different. For example, the loading state can be weighted less than the waiting times. In particular, a corresponding listing with the corresponding weights, for example a monetary evaluation of the freight orders, can then be carried out. This allows an improved evaluation of the freight order to be carried out.

Another aspect of the invention relates to a freight order evaluation system for evaluating a freight order for a lorry having an electronic computing device, wherein the freight order evaluation system is designed to perform a method according to any of the preceding aspects. In particular, the method is performed by means of the freight order evaluation system.

Advantageous embodiments of the method are to be regarded as advantageous embodiments of the freight order evaluation system. For this purpose, the freight order evaluation system has material features which enable the method or an advantageous embodiment thereof to be carried out.

Further advantages, features and details of the invention will become apparent from the following description of a preferred exemplary embodiment and from the drawing. The features and combinations of features mentioned above in the description as well as the features and combinations of features mentioned below in the description of the figure and/or shown alone in the single figure (FIG.) can be used not only in the combination indicated in each case, but also in other combinations or on their own, without departing from the scope of the invention.

### BRIEF DESCRIPTION OF THE DRAWING

The single FIG. shows here a schematic side view of an embodiment of a freight order evaluation system.

### DETAILED DESCRIPTION OF THE DRAWING

In the FIG. the same or functionally identical elements are provided with the same reference signs.

The FIG. shows a schematic side view of an embodiment of a freight order evaluation system 10. The freight order evaluation system 10 is designed for evaluating a freight order 12 for a lorry 14. The freight order evaluation system 10 comprises an electronic computing device 16. In the present exemplary embodiment, the electronic computing device 16 is external to the lorry. For example, the electronic computing device 16 may be provided as a back-end server or a cloud server.

In the method for evaluating a freight order 12, a waiting time 18 of the lorry 14 is recorded and, depending on the recorded waiting time 18, a route 20 of the lorry 14 is determined. The freight order 12 is evaluated in dependence thereon by means of the electronic computing device 16.

It is provided that a loading state 22 of the lorry 14 is detected during the route 20 and, in addition, the freight order 12 is evaluated by means of the electronic computing device in dependence on the detected loading state 22.

This makes it possible that, in an improved fashion, the freight order 12 is not only evaluated on the basis of the waiting times 18, but also on the basis of the loading state 22. In particular, this enables the freight order 12 to be evaluated also in monetary terms, for example. Thus, a dispatcher can decide whether the freight order 12 is accepted or not. Thus, an evaluation takes place with regard to the waiting times 18 and the loading state 22.

The loading state 22 can be considered to be, in particular, a full load, a partial load or an empty run.

In particular, variable costs and fixed costs, for example, can also be input by the dispatcher into the freight order evaluation system 10 by means of an input device 24. In particular, by using the waiting times 18 and by using the loading state 22, costs can thus be determined for the evaluation of the freight order 12, for example.

Preferably, it can be provided that a plurality of freight orders 12 are processed during a route 20. In other words, a plurality of freight orders 12 can be carried out with one route 20. For this purpose, the lorry 14 may travel from a first destination, where, for example, a first freight order 12 is accepted, to a second destination, where, for example, a second freight order 12 is accepted. At a third location, for example, both freight orders 12 can then be completed. In particular, this allows, for example, empty runs to be recorded as a loading state 22 or only a partial loading state. Thus, loading and unloading times can be taken into account in the evaluation of the freight order 12.

By means of the freight order evaluation system 10, corresponding times and costs incurred on specific routes 20 can thus be taken into account, so that an estimate of the profitability for the future route 20 can be carried out by means of the freight order evaluation system 10.

Furthermore, by means of the freight order evaluation system 10, it is possible for the freight orders 12 to be evaluated accordingly by a transport provider and to be stored, for example, in the electronic computing device 16 of the freight order evaluation system 12. These can then be listed, wherein a particularly positively rated freight order 12 is rated higher than a negative freight order 12. Thus, for example, an output relating to the rating of the ordering party can also be provided. In particular, this makes it possible for a user of the freight order evaluation system 10 to evaluate the customer accordingly, so that in particular corresponding order conditions can be negotiated in an improved manner.

In particular, it can be provided that, depending on the evaluation of the freight order 12, the freight order 12 is automatically accepted by means of the electronic computing device 16. In particular, historical data regarding the freight order 12 can be available for this purpose, which enables an evaluation of the freight order 12.

Furthermore, it may be provided that the freight order evaluation system 10 comprises the input device 24, and, by input of a user of the freight order evaluation system 10, the waiting time 18 and/or the loading state 22 are detected. Furthermore, position information of a navigation device 26 of the freight lorry 14 may be used to determine the waiting time 18 and/or loading state information may be used to determine the loading state 22. In other words, it may be envisaged, for example, that the waiting times 18 and/or the loading state 22 are input manually by the user. In particular, this is historical data relating to the waiting time 18 and/or the loading state 22. In particular, this enables this freight order 12 or a similar freight order 12 to be reliably evaluated in the future. In this way, an improved freight order evaluation system 10 can be provided.

In particular, a freight 28 can be evaluated with respect to its properties for this purpose. For example, a volume of the freight 28, a weight of the freight 28, a shape of the freight 28 or a monetary value of the freight 28 can be used accordingly to evaluate the freight order 12.

Furthermore, it may be provided that the freight order 12 is additionally evaluated depending on a driver occupation state of a driver of the lorry 14 during the route 20. For example, the driver occupation state can be determined by means of an application of a mobile terminal 30 of the driver. In particular, this can provide detailed information regarding the current occupation state of the driver. In particular, this can be used for waiting times 18 of the driver, for example in front of a loading ramp, at a border or at further checkpoints. The mobile terminal 30 can, for example, be designed as an intelligent telephone, a so-called smartphone. In this way, the driving task 12 can be evaluated reliably and with reduced effort.

In particular, it is provided that the freight order 12 is additionally evaluated in dependence on a freight type of the freight order 12, in other words in dependence on the freight 28, during the route 20.

In particular, it is provided that at least the waiting time 18 and/or the loading state 22 are stored in a memory device 32 of the freight order evaluation system 10, and the freight order 12 is evaluated in dependence on the stored waiting time 18 and/or the stored loading state 22. In particular, the freight order 12 can thus also be evaluated on the basis of historical data relating to the freight order 12. In this regard, the storage device 32 may be provided internally of the lorry or, alternatively, the storage device 32 may be provided as a storage device 32 external to the lorry, as in the present case. For example, the storage device 32 may be provided in the form of a back-end server or in the form of a cloud server. This enables the information relating to the waiting time 18 and the loading state 22 to be transmitted to the back-end server, for example by means of a transmission device of the lorry 14, whereby a user of the freight order evaluation system 10 can access this information directly and evaluate the freight order 12 at an early stage. In particular, the historical information, i.e., the stored waiting time 18 and/or the stored loading state 22, can be used to reliably evaluate the particular freight order 12. In particular, this allows a listing of the various freight orders 12 with respect to their profitability to be performed. In this way, a reliable evaluation of the freight order 12 can be carried out.

In particular, it may be provided that the route 20 is determined depending on at least two evaluated freight orders 12, in particular depending on a plurality of evaluated freight orders 12, by means of the freight order evaluation system 10. The term “a plurality” means in particular more than two freight orders 12. In particular, an optimal route 20 is then determined by means of the freight order evaluation system 10 depending on the plurality of freight orders 12. In particular, the corresponding waiting time 18 and the corresponding loading state 22 can then be taken into account when determining the route 20, whereby the route 20 can be determined in an improved manner. In particular, a profitability of the route 20 can be determined in an improved manner.

Furthermore, it may be provided that at least the waiting time 18 and/or the loading state 20 are weighted in dependence on a decision criterion, and the freight order 12 is evaluated in dependence on the weighted waiting time 18 and in the weighted loading state 20. In other words, the waiting time 18 and the loading state 22 can be weighted differently. For example, a monetary value may be assigned to both the waiting times 18 and the loading states 22 for this purpose. These values can be different. For example, the loading state 22 can be weighted less than the waiting times 18. In particular, a corresponding listing can then be carried out with the corresponding weights, for example a monetary evaluation of the freight orders 12. This allows an improved evaluation of the freight order 12 to be carried out.

In particular, the freight order evaluation system 10 can be designed to support a dispatcher. For example, weekly profiles can be created that can determine the ineffectiveness or profitability of an individual route 20 in the future. In particular, historical data of a similar route 20 or the same route 20 can be used for this purpose.

Furthermore, it can be provided that the freight orders 12 are evaluated, for example, with regard to their loading and unloading time. For this purpose, a list 34 can be created which assigns a rank to the various freight orders 12. In particular, it can be provided that the freight order 12 is accepted depending on the corresponding rank. Furthermore, it can be provided that a corresponding transparency is created for the dispatcher, for example by means of the input device 24, which indicates to the dispatcher in which region, for example, the lorry 14 is currently located. Furthermore, the freight 28 can, for example, be monetarily evaluated, in which case monetary values are assigned in particular to the loading state 22 and the waiting time 18, and the freight order evaluation system 10 can then determine, for example, whether the freight order 12 is correspondingly profitable. In particular, a future route 20 can thus also be determined and evaluated by means of the freight order evaluation system 10.

In particular, by means of the freight order evaluation system 10, the dispatcher can be given an overview, for example on the input device 24, of the corresponding waiting times 18 and loading states 22, in particular of the future waiting times 18 and future loading states 22 along the route 20. Thus, the dispatcher can already view the plan of the route 20 in the future and take it into account accordingly. In the case of the list 34, it may be provided, for example, that the freight order 12 is evaluated with respect to a highest loading time, a highest unloading time or a longest empty run. Alternatively or additionally, all three evaluations can be taken into account.

Furthermore, an overview can be created by means of the freight order evaluation system 10, in which a dispatcher or a user of the freight order evaluation system 10 receives an overview of the location at which, for example, a freight 28 is unloaded or loaded. Furthermore, corresponding borders and customs regulations can also be taken into account when determining the route 20.

The freight order evaluation system 10 according to the invention thus makes it possible that, for example, a user of the freight order evaluation system 10 or a dispatcher can accept or decline a corresponding freight order 12 in a simplified manner. Furthermore, it can be provided that the freight order evaluation system 10 can automatically accept the freight order 12, for example depending on a threshold value for the evaluation, for example depending on a ranking position of the evaluation of the freight order 12.

1.-11. (canceled)

12. A method for evaluating a freight order (12) for a lorry (14) by a freight order evaluation system (10), comprising the steps of:
detecting a waiting time (18) of the lorry (14);
determining a route (20) of the lorry (14) depending on the waiting time (18);
detecting a loading state (22) of the lorry (14) during the route (20); and
evaluating the freight order (12) depending on the waiting time (18) and the loading state (22) by an electronic computing device (16) of the freight order evaluation system (10).

13. The method according to claim 12, further comprising the step of automatically accepting the freight order (12) by the electronic computing device (16) depending on the evaluating of the freight order (12).

14. The method according to claim 12, wherein the freight order evaluation system (10) includes an input device (24) and wherein the waiting time (18) and the loading state (22) are detected by input of a user in the input device (24).

15. The method according to claim 12, wherein position information of a navigation device (26) of the lorry (14) is used to detect the waiting time (18) and wherein loading state information is used to detect the loading state (22).

16. The method according to claim 12, wherein the freight order (12) is additionally evaluated depending on a driver occupation state of a driver of the lorry (14) during the route (20).

17. The method according to claim 16, wherein the driver occupation state is determined via an application of a mobile terminal (30) of the driver.

18. The method according to claim 12, wherein the freight order (12) is additionally evaluated depending on a freight type of the freight order (12) during the route (20).

19. The method according to claim 12, wherein the waiting time (18) and the loading state (22) are stored in a memory device (32) of the freight order evaluation system (10) and wherein the freight order (12) is evaluated depending on the stored waiting time (18) and the stored loading state (22).

20. The method according to claim 12, wherein the route (20) is determined by the freight order evaluation system (10) depending on at least two evaluated freight orders (12).

21. The method according to claim 12, wherein the waiting time (18) and the loading state (22) are weighted depending on a decision criterion and wherein the freight order (12) is evaluated depending on the weighted waiting time (18) and the weighted loading state (22).

22. A freight order evaluation system (10) for evaluating a freight order (12) for a lorry (14), comprising:
an electronic computing device (16), wherein the freight order evaluation system (10) performs the method according to claim 12.
